(19) United States
(12) Patent Application Publication
(10) Pub. No.: US 2025/0351216 A1
(43) Pub. Date: Nov. 13, 2025

(54) TECHNIQUES FOR MANAGING NETWORK CONNECTIONS FOR PUSH NOTIFICATIONS

(71) Applicant: Apple Inc., Cupertino, CA (US)

(72) Inventor: Aniket A. ZAMWAR, Milpitas, CA (US)

(21) Appl. No.: 19/188,732

(22) Filed: Apr. 24, 2025

Related U.S. Application Data
(60) Provisional application No. 63/646,141, filed on May 13, 2024.

(51) Int. Cl. H04W 76/25; H04L 67/55; H04W 76/10; H04W 80/06

(52) U.S. Cl. CPC H04W 76/25; H04L 67/55; H04W 76/10; H04W 80/06

(57) ABSTRACT

Techniques for managing network connections for push notifications is disclosed. A method can include establishing a network connection with a wireless device that can transmit keepalive messages to the push notification server at a first predetermined time interval, receiving push notifications directed to the wireless device, transmitting, to the wireless device, a first push notification of received push notifications. The first push notification may be accompanied with first information that causes the wireless device to withhold establishing a second predetermined time interval for transmitting keepalive messages. The method may also include transmitting, to the wireless device, a last push notification of the received notifications. The last push notification may be accompanied with second information that causes the wireless device to establish the second predetermined time interval for transmitting keepalive messages.

### CROSS-REFERENCE TO RELATED APPLICATIONS

The present application claims the benefit of U.S. Provisional Application No. 63/646,141, entitled “TECHNIQUES FOR MANAGING NETWORK CONNECTIONS FOR PUSH NOTIFICATIONS,” filed May 13, 2024, the content of which is incorporated by reference herein in its entirety for all purposes.

### FIELD

This disclosure relates to techniques for managing network connections for push notifications and, more particularly, to techniques for adjusting the manner in which keepalive messages are transmitted between push notification servers and wireless devices over network connections to promote power savings.

### BACKGROUND

Keepalive signals are essential for maintaining active network connections on mobile devices, particularly in the context of push notifications. However, these signals, which serve to sustain the network connection between a given mobile device and a push notification server, can contribute to battery drain on the mobile device. In particular, as the mobile device sends and receives these signals to keep the network connection alive, the mobile device remains in a state of heightened activity, thereby consuming significant amounts of battery power. In this regard, the ongoing network activity that takes place can substantially impact battery life over time.

Accordingly, what is needed is an improved technique for managing network connections for push notifications.

### SUMMARY

This Application sets forth techniques for managing network connections for push notifications. M ore particularly, the described aspects set forth techniques for adjusting the manner in which keepalive messages are transmitted between push notification servers and wireless devices over network connections to promote power savings.

One aspect sets forth a method for managing network connections for push notifications. According to some aspects, the method can be implemented by a push notification server, and includes the steps of establishing a network connection with a wireless device, wherein the wireless device is configured to transmit keepalive messages to the push notification server at a first predetermined time interval, receiving two or more push notifications directed to the wireless device, transmitting, to the wireless device, a first push notification of the two or more push notifications, wherein the first push notification is accompanied with first information that causes the wireless device to withhold establishing a second predetermined time interval for transmitting keepalive messages, and transmitting, to the wireless device, a last push notification of the two or more push notifications, wherein the last push notification is accompanied with second information that causes the wireless device to establish, without delay, the second predetermined time interval for transmitting keepalive messages.

Another aspect sets forth a method for managing network connections for push notifications. According to some aspects, the method can be implemented by a wireless device, and includes the steps of establishing a network connection with a push notification server, wherein the wireless device is configured to transmit keepalive messages to the push notification server at a first predetermined time interval, receiving, from the push notification server, a first push notification of two or more push notifications that are received by the push notification server and directed to the wireless device, wherein the first push notification is accompanied with first information that causes the wireless device to withhold establishing a second predetermined time interval for transmitting keepalive messages, and receiving, from the push notification server, a last push notification of the two or more push notifications, wherein the last push notification is accompanied with second information that causes the wireless device to establish, without delay, the second predetermined time interval for transmitting keepalive messages.

Other aspects include a non-transitory computer readable storage medium configured to store instructions that, when executed by a processor included in a computing device, cause the computing device to carry out the various steps of any of the foregoing methods. Further aspects include a computing device that is configured to carry out the various steps of any of the foregoing methods.

Other aspects and advantages of the disclosure will become apparent from the following detailed description taken in conjunction with the accompanying drawings which illustrate, by way of example, the principles of the disclosure.

This Summary is provided merely for purposes of summarizing some example aspects so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement the various techniques described herein, according to some embodiments.

FIG. 2 illustrates a block diagram of a more detailed view of exemplary components of the system of FIG. 1, according to some embodiments.

FIG. 3 illustrates an exemplary device activation and provisioning network for a wireless device, according to some embodiments.

FIG. 4 illustrates a method implemented by a push notification server for managing network connections for push notifications, according to some embodiments.

FIG. 5 illustrates a method implemented by a wireless device for managing network connections for push notifications, according to some embodiments.

FIG. 6 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

This Application sets forth techniques for managing network connections for push notifications. M ore particularly, the described embodiments set forth techniques for adjusting the manner in which keepalive messages are transmitted between push notification servers and wireless devices over network connections to promote power savings.

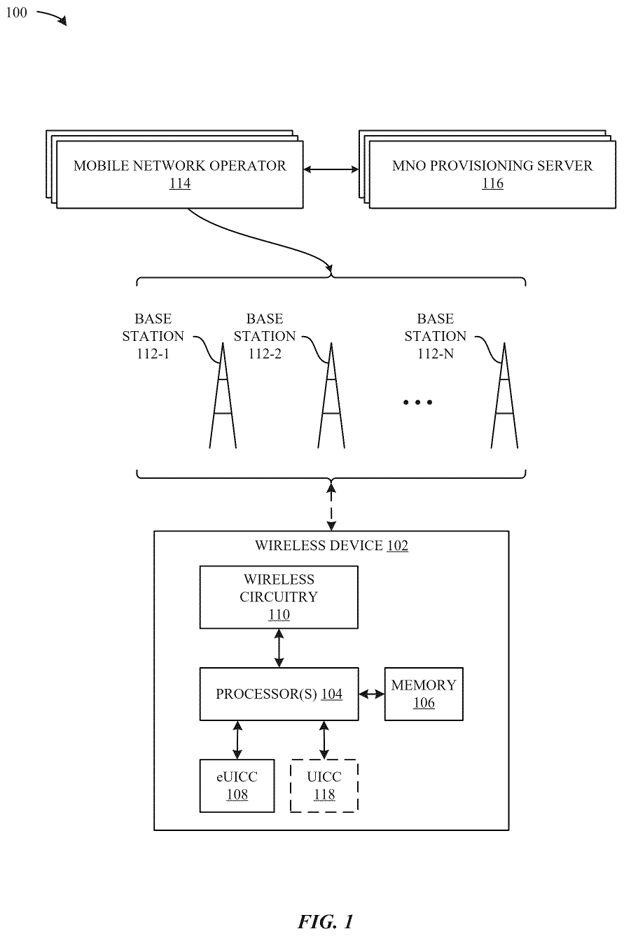

FIG. 1 illustrates a block diagram of different components of a system 100 that is configured to implement the various techniques described herein, according to some embodiments. M ore specifically, FIG. 1 illustrates a high-level overview of the system 100, which, as shown, includes a wireless device 102, which can also be referred to as a mobile wireless device, a cellular wireless device, a mobile device, a user equipment (UE) and the like, a group of base stations 112-1 to 112-N that are managed by different Mobile Network Operators (MNOs) 114, and a set of provisioning servers 116 that are in communication with the MNOs 114. Additional MNO infrastructure servers, such as used for account management and billing are not shown. The wireless device 102 can represent a mobile computing device (e.g., an iPhone®, an iPad®, an Apple Watch®, etc., by Apple®), the base stations 112-1 to 112-n can represent cellular wireless network entities including evolved NodeBs (eNodeBs or eNBs) and/or next generation NodeBs (gNodeBs or gNB) that are configured to communicate with the wireless device 102, and the MNO s 114 can represent different wireless service providers that provide specific cellular wireless services (e.g., voice and data) to which the wireless device 102 can subscribe, such as via a subscription account for a user of the wireless device 102.

As shown in FIG. 1, the wireless device 102 can include processing circuitry, which can include one or more processor(s) 104 and a memory 106, an embedded Universal Integrated Circuit Card (eUICC) 108, and baseband wireless circuitry 110 used for transmission and reception of cellular wireless radio frequency signals. The baseband wireless circuitry 110 can include analog hardware components, such as antennas and amplifiers, as well as digital processing components, such as signal processors (and/or general/limited purpose processors) and associated memory. In some embodiments, the wireless device 102 includes one or more physical UICCs 118, also referred to as Subscriber Identity Module (SIM) cards, in addition to or substituting for the eUICC 108. The components of the wireless device 102 work together to enable the wireless device 102 to provide useful features to a user of the wireless device 102, such as cellular wireless network access, non-cellular wireless network access, localized computing, location-based services, and Internet connectivity.

According to some embodiments, the eUICC 108 can be configured to store multiple electronic SIMs (eSIMs) for accessing cellular wireless services provided by different MNOs 114 by connecting to their respective cellular wireless networks through base stations 112-1 to 112-N. For example, the eUICC 108 can be configured to store and manage one or more eSIMs for one or more MNOs 114 for different subscriptions to which the wireless device 102 is associated. To be able to access services provided by an MNO, an eSIM is reserved for subsequent download and installation to the eUICC 108. In some embodiments, the eUICC 108 obtains one or more eSIMs from one or more associated MNO provisioning servers 116 as part of a device initialization of the wireless device 102, such as when purchasing a new wireless device 102. The provisioning servers 116 can be maintained by a manufacturer of the wireless device 102, the MNOs 114, third party entities, and the like. Communication of eSIM data between an MNO provisioning server 116 and the eUICC 108 (or between the MNO provisioning server 116 and processing circuitry of the wireless device 102 external to the eUICC 108, e.g., the processor 104) can use a secure communication channel.

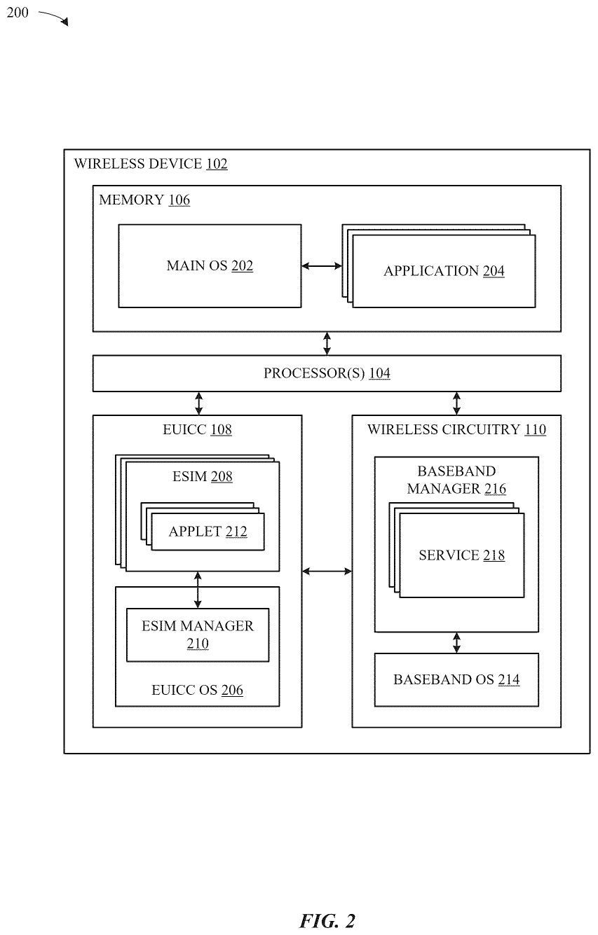

FIG. 2 illustrates a block diagram of a more detailed view 200 of particular components of the wireless device 102 of FIG. 1, according to some embodiments. As shown in FIG. 2, the processor(s) 104, in conjunction with memory 106, can implement a main operating system (OS) 202 that is configured to execute applications 204 (e.g., native OS applications and user applications). As also shown in FIG. 2, the eUICC 108 can be configured to implement an eUICC OS 206 that is configured to manage hardware resources of the eUICC 108 (e.g., a processor and a memory embedded in the eUICC 108). The eUICC OS 206 can also be configured to manage eSIMs 208 that are stored by the eUICC 108, e.g., by downloading, installing, deleting, enabling, disabling, modifying, or otherwise performing management of the eSIMs 208 within the eUICC 108 and providing baseband wireless circuitry 110 with access to the eSIMs 208 to provide access to wireless services for the wireless device 102. The eUICC 108 OS can include an eSIM manager 210, which can perform management functions for various eSIMs 208. According to the illustration shown in FIG. 2, each eSIM 208 can include a number of applets 212 that define the manner in which the eSIM 208 operates. For example, one or more of the applets 212, when implemented in conjunction with baseband wireless circuitry 110 and the eUICC 108, can be configured to enable the wireless device 102 to communicate with an MNO 114 and provide useful features (e.g., phone calls and internet access) to a user of the wireless device 102.

As also shown in FIG. 2, the baseband wireless circuitry 110 of the wireless device 102 can include a baseband OS 214 that is configured to manage hardware resources of the baseband wireless circuitry 110 (e.g., a processor, a memory, different radio components, etc.). According to some embodiments, the baseband wireless circuitry 110 can implement a baseband manager 216 that is configured to interface with the eUICC 108 to establish a secure channel with an MNO provisioning server 116 and obtain information (such as eSIM data) from the MNO provisioning server 116 for purposes of managing eSIMs 208. The baseband manager 216 can be configured to implement services 218, which represents a collection of software modules that are instantiated by way of the various applets 212 of enabled eSIMs 208 that are included in the eUICC 108. For example, services 218 can be configured to manage different connections between the wireless device 102 and MNO s 114 according to the different eSIMs 208 that are enabled within the eUICC 108.

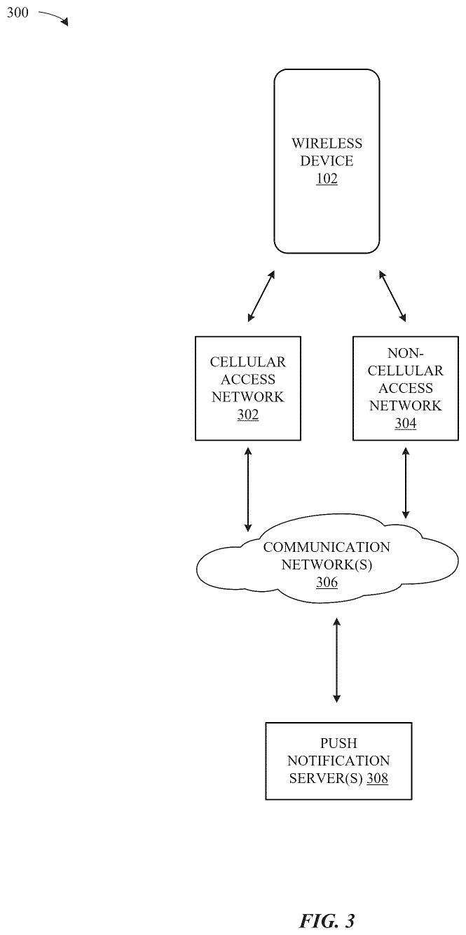

FIG. 3 illustrates a diagram 300 of elements of a communication network that can be used to facilitate transmitting push notifications between wireless devices 102 and push notification servers 308. As shown in FIG. 3, given wireless device 102 can communicate with one or more push notification servers 308 by way of a cellular access network 302 (e.g., implemented by a mobile network operator 114 that provides Internet access) or a non-cellular access network 304 (e.g., a WiFi connection through which the Internet is accessible). According to some embodiments, the wireless device 102 and the push notification server 308 can utilize Transmission Control Protocol/Internet Protocol (TCP/IP) frameworks to establish a network connection between the wireless device 102 and the push notification server 308 to enable push notifications to be transferred therebetween.

According to some embodiments, when a network connection has been established between the wireless device 102 and the push notification server 308, the wireless device 102 and the push notification server 308 can agree on a predetermined time interval at which the wireless device 102 is to communicate keepalive messages to the push notification server 308. In particular, the wireless device 102 can be configured to transmit a keepalive message to the push notification server 308 each time the predetermined time interval lapses and when no push notifications are received by the wireless device 102 during the predetermined time interval (as the receipt of at least one push notification indicates that the network connection is viable, thereby eliminating the need to issue another keepalive message, at least in accordance with the current predetermined time interval).

Conversely, when at least one push notification is received during the predetermined time interval, the wireless device 102 is configured to reset the predetermined time interval (through a series of communications with the push notification server 308). Notably, resetting the predetermined time interval can be inefficient, especially in situations where two or more push notifications are received by the push notification server 308 and are to be sequentially transmitted to the wireless device 102. In particular, the wireless device 102, at least under the aforementioned configuration, would reset the predetermined time interval between receipts of at least the first and second push notifications, which unnecessarily consumes network bandwidth and power (given the wireless device 102 would perform a final reset after the last push notification of the two or more push notifications is received, where the final reset effectively obviates all other resets that occur after each push notification of the two or more push notifications are received).

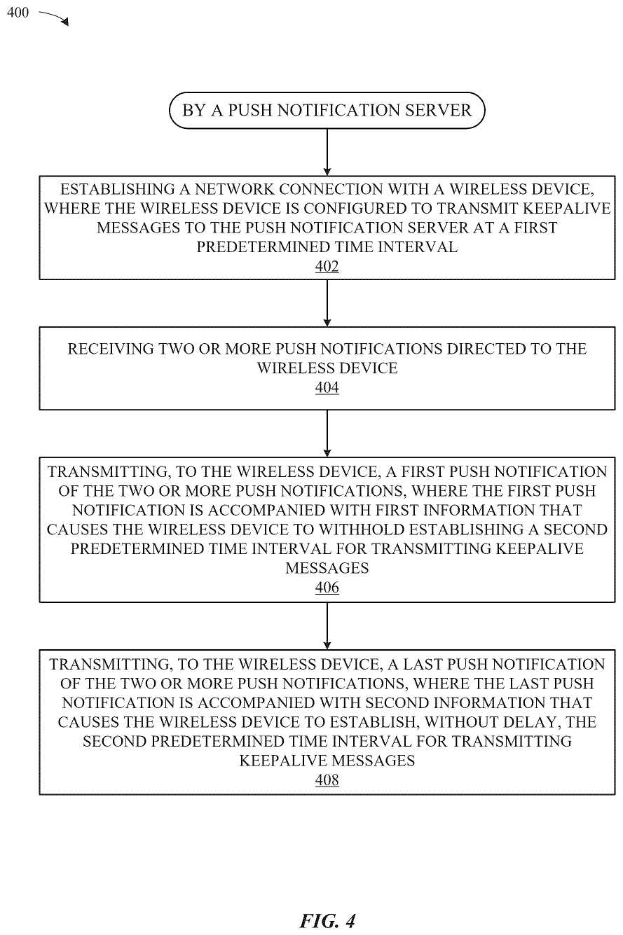

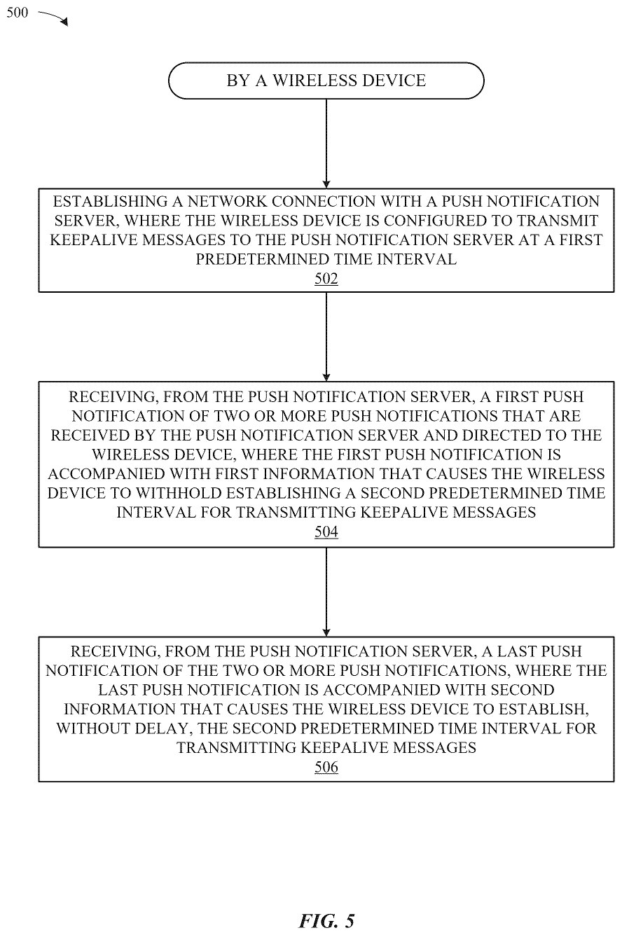

Accordingly, FIGS. 4-5 set forth methods that can be implemented by the push notification server 308 and the wireless device 102, respectively, to mitigate the predetermined time interval reset inefficiencies described above in conjunction with FIG. 3.

FIG. 4 illustrates a method 400 for managing network connections for push notifications, according to some embodiments. According to some embodiments, the method 400 can be implemented by the push notification server 308 described above in conjunction with FIG. 3. As shown in FIG. 4, the method 400 begins at step 402, where the push notification server 308 establishes a network connection with a wireless device 102, where the wireless device 102 is configured to transmit keepalive messages to the push notification server 308 at a first predetermined time interval (e.g., as described above in conjunction with FIG. 3).

At step 404, the push notification server 308 receives two or more push notifications directed to the wireless device 102. For example, the two or more push notifications can each be associated with the same recipient unique identifier (ID) that corresponds to the wireless device 102. In one example scenario, each push notification of the two or more push notifications can be tagged to indicate that they should be delivered to the wireless device 102 as soon as possible. In another example scenario, the push notification server 308 can receive an indication (e.g., from a push notification server associated with an application 204) that at least one additional push notification will be provided within a threshold period of time, such that it would be prudent for the push notification server 308 to indicate to the wireless device 102 that the wireless device 102 should refrain from performing a predetermined time interval reset (in accordance with the techniques described below in conjunction with steps 406 and 408). It is noted that the foregoing examples are not meant to be limiting, and that the push notification server 308 can indicate to the wireless device 102 that the wireless device 102 should refrain from resetting the predetermined time interval based on any amount, type, form, etc., of information (provided by any number, type, form, etc., of entity/entities), at any level of granularity, consistent with the scope of this disclosure.

At step 406, the push notification server 308 transmits, to the wireless device 102, a first push notification of the two or more push notifications, where the first push notification is accompanied with first information that causes the wireless device 102 to withhold establishing a second predetermined time interval (i.e., a reset) for transmitting keepalive messages. Under a first example approach, the first information can constitute a binary variable that can be assigned a value of true or false, where true indicates that the wireless device 102 should perform a reset after the first push notification is received, and false indicates the wireless device 102 should refrain from performing a reset after the first push notification is received (or vice-versa). Under a second example approach, the first information can constitute an integer variable that can be assigned a value equal to the number of push notifications that will follow the push notification (which can be determined by the push notification server 308). In this manner, the wireless device 102 is rendered capable of identifying when a predetermined time interval reset should be carried out (i.e., after the last push notification of the two or more push notifications is received). It is noted that the foregoing examples are not meant to be limiting, and that the first information can include any amount, type, form, etc., of information, at any level of granularity, to effectively convey to the wireless device 102 how, when, etc., the wireless device 102 should (or should not) carry out a predetermined time interval reset procedure, consistent with the scope of this disclosure.

At step 408, the push notification server 308 transmits, to the wireless device 102, a last push notification of the two or more push notifications, where the last push notification is accompanied with second information that causes the wireless device 102 to establish, without delay, the second predetermined time interval for transmitting keepalive messages. W hen the first example approach described above at step 406 is implemented, the second information can constitute a binary variable that can be assigned a value of true or false, where true indicates that the wireless device 102 should perform a reset after the push notification is received, and false indicates the wireless device 102 should refrain from performing the reset after the push notification is received (or vice-versa). Alternatively, when the second example approach described above at step 406 is implemented, the second information can be withheld, as the wireless device 102 is already aware that the last push notification is, in fact, the last push notification, and that the predetermined time interval reset should be performed. Again, it is noted that the foregoing examples are not meant to be limiting, and that the second information can include any amount, type, form, etc., of information, at any level of granularity, to effectively convey to the wireless device 102 how the wireless device 102 should (or should not) carry out a predetermined time interval reset procedure, consistent with the scope of this disclosure.

FIG. 5 illustrates a method 500 for managing network connections for push notifications, according to some embodiments. According to some embodiments, the method 400 can be implemented by the wireless device 102 described above in conjunction with FIGS. 1-3. As shown in FIG. 5, the method 500 begins at step 502, where the wireless device 102 establishes a network connection with a push notification server 308, where the wireless device 102 is configured to transmit keepalive messages to the push notification server 308 at a first predetermined time interval (e.g., as described above in conjunction with FIGS. 3-4).

At step 504, the wireless device 102 receives, from the push notification server 308, a first push notification of two or more push notifications that are received by the push notification server 308 and directed to the wireless device 102, where the first push notification is accompanied with first information that causes the wireless device 102 to withhold establishing a second predetermined time interval for transmitting keepalive messages (e.g., as described above in conjunction with FIGS. 3-4).

At step 506, the wireless device 102 receives, from the push notification server 308, a last push notification of the two or more push notifications, where the last push notification is accompanied with second information that causes the wireless device 102 to establish, without delay, the second predetermined time interval for transmitting keepalive messages (e.g., as described above in conjunction with FIGS. 3-4).

### Representative Device

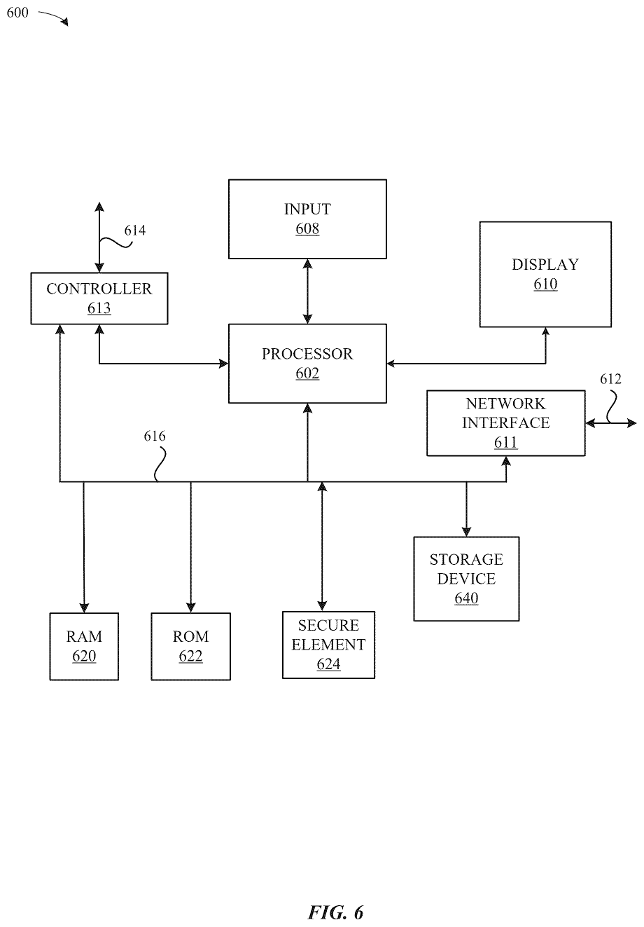

FIG. 6 illustrates a detailed view of a representative computing device 600 that can be used to implement various methods described herein, according to some embodiments. In particular, the detailed view illustrates various components that can be included in the wireless device 102. As shown in FIG. 6, the computing device 600 can include a processor 602 that represents a microprocessor or controller for controlling the overall operation of computing device 600. The computing device 600 can also include a user input device 608 that allows a user of the computing device 600 to interact with the computing device 600. For example, the user input device 608 can take a variety of forms, such as a button, keypad, dial, touch screen, audio input interface, visual/image capture input interface, input in the form of sensor data, etc. Still further, the computing device 600 can include a display 610 that can be controlled by the processor 602 to display information to the user. A data bus 616 can facilitate data transfer between at least a storage device 640, the processor 602, and a controller 613. The controller 613 can be used to interface with and control different equipment through an equipment control bus 614. The computing device 600 can also include a network/bus interface 611 that communicatively couples to a data link 612. In the case of a wireless connection, the network/bus interface 611 can include a wireless transceiver.

The computing device 600 also includes a storage device 640, which can comprise a single disk or a plurality of disks (e.g., hard drives), and includes a storage management module that manages one or more partitions within the storage device 640. In some embodiments, storage device 640 can include flash memory, semiconductor (solid state) memory or the like. The computing device 600 can also include a Random Access Memory (RAM) 620 and a Read-Only Memory (ROM) 622. The ROM 622 can store programs, utilities or processes to be executed in a non-volatile manner. The RAM 620 can provide volatile data storage, and stores instructions related to the operation of the computing device 600. The computing device 600 can further include a secure element (SE) 624, which can represent secure storage for cellular wireless system access by the wireless device 102, such as an eUICC 108 on which to store one or more eSIMs 208 and/or a UICC 118 on which to store a physical SIM (pSIM) profile.

### Wireless Terminology

In accordance with various embodiments described herein, the terms “wireless communication device,” “wireless device,” “mobile wireless device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (W PA N), a nearfield communication (N FC), a cellular wireless network, a fourth generation (4G) Long Term Evolution (LTE), LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a W PA N and/or an “ad hoc” wireless network. In some embodiments, the client device can be any wireless communication device that is capable of communicating via a W LAN technology, e.g., in accordance with a wireless local area network communication protocol. In some embodiments, the W LAN technology can include a Wi-Fi (or more generically a W LAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode UE can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High-Speed Packet Access (HSPA+) network or a Code Division MultipleAccess (CDMA) 2000 Evolution-Data Only (EV-DO) network, when LTE and LTE-A networks are otherwise unavailable.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

Regarding the present disclosure, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for managing a network connection for push notifications, the method comprising, by a push notification server:
establishing the network connection with a wireless device, wherein the wireless device is configured to transmit keepalive messages to the push notification server at a first predetermined time interval;
receiving two or more push notifications directed to the wireless device;
transmitting, to the wireless device, a first push notification of the two or more push notifications, wherein the first push notification is accompanied with first information that causes the wireless device to withhold establishing a second predetermined time interval for transmitting keepalive messages; and
transmitting, to the wireless device, a last push notification of the two or more push notifications, wherein the last push notification is accompanied with second information that causes the wireless device to establish, without delay, the second predetermined time interval for transmitting keepalive messages.

2. The method of claim 1, further comprising transmitting at least one push notification of the two or more push notifications between the first push notification and the last push notification, and wherein the at least one push notification is unaccompanied by any information that would cause the wireless device to take action with respect to establishing the second predetermined time interval.

3. The method of claim 1, wherein the second information further causes the wireless device, subsequent to establishing the second predetermined time interval, to transition into a dormant state with respect to managing the network connection.

4. The method of claim 3, wherein the wireless device remains in the dormant state between transmitting keepalive messages with respect to the first and second predetermined time intervals.

5. The method of claim 1, wherein:
the second information specifies the second predetermined time interval; and
the second predetermined time interval is based on a device type of the wireless device, an operating system (OS) type of the wireless device, respective types of one or more applications installed on the wireless device, or some combination thereof.

6. The method of claim 1, wherein the second predetermined time interval is longer when the wireless device is a wearable computing device compared to a mobile computing device, and vice-versa.

7. The method of claim 1, wherein the network connection is formed using Transmission Control Protocol/Internet Protocol (TCP/IP) frameworks.

8. A method for managing a network connection for push notifications, the method comprising, by a wireless device:
establishing the network connection with a push notification server, wherein the wireless device is configured to transmit keepalive messages to the push notification server at a first predetermined time interval;
receiving, from the push notification server, a first push notification of two or more push notifications that are received by the push notification server and directed to the wireless device, wherein the first push notification is accompanied with first information that causes the wireless device to withhold establishing a second predetermined time interval for transmitting keepalive messages; and
receiving, from the push notification server, a last push notification of the two or more push notifications, wherein the last push notification is accompanied with second information that causes the wireless device to establish, without delay, the second predetermined time interval for transmitting keepalive messages.

9. The method of claim 8, further comprising receiving at least one push notification of the two or more push notifications between the first push notification and the last push notification, wherein the at least one push notification is unaccompanied by any information that would cause the wireless device to take action with respect to establishing the second predetermined time interval.

10. The method of claim 8, wherein the second information further causes the wireless device, subsequent to establishing the second predetermined time interval, to transition into a dormant state with respect to managing the network connection.

11. The method of claim 10, wherein the wireless device remains in the dormant state between transmitting keepalive messages with respect to the first and second predetermined time intervals.

12. The method of claim 8, wherein:
the second information specifies the second predetermined time interval; and
the second predetermined time interval is based on a device type of the wireless device, an operating system (OS) type of the wireless device, respective types of one or more applications installed on the wireless device, or some combination thereof.

13. The method of claim 8, wherein the second predetermined time interval is longer when the wireless device is a wearable computing device compared to a mobile computing device, and vice-versa.

14. The method of claim 8, wherein the network connection is formed using Transmission Control Protocol/Internet Protocol (TCP/IP) frameworks.

15. A computing device, comprising:
at least one processor; and
at least one memory configured to store instructions that, when executed by the at least one processor, cause the computing device to perform operations for managing a network connection for push notifications, wherein the operations include:
establishing the network connection with a wireless device, wherein the wireless device is configured to transmit keepalive messages to a push notification server at a first predetermined time interval;
receiving two or more push notifications directed to the wireless device;
transmitting, to the wireless device, a first push notification of the two or more push notifications, wherein the first push notification is accompanied with first information that causes the wireless device to withhold establishing a second predetermined time interval for transmitting keepalive messages; and
transmitting, to the wireless device, a last push notification of the two or more push notifications, wherein the last push notification is accompanied with second information that causes the wireless device to establish, without delay, the second predetermined time interval for transmitting keepalive messages.

16. The computing device of claim 15, wherein the operations further include transmitting at least one push notification of the two or more push notifications between the first push notification and the last push notification, and wherein the at least one push notification is unaccompanied by any information that would cause the wireless device to take action with respect to establishing the second predetermined time interval.

17. The computing device of claim 15, wherein the second information further causes the wireless device, subsequent to establishing the second predetermined time interval, to transition into a dormant state with respect to managing the network connection.

18. The computing device of claim 17, wherein the wireless device remains in the dormant state between transmitting keepalive messages with respect to the first and second predetermined time intervals.

19. The computing device of claim 15, wherein the second information specifies the second predetermined time interval, and wherein the second predetermined time interval is based on a device type of the wireless device, an operating system (OS) type of the wireless device, respective types of one or more applications installed on the wireless device, or some combination thereof.

20. The computing device of claim 15, wherein the second predetermined time interval is longer when the wireless device is a wearable computing device compared to a mobile computing device, and vice-versa.
